(19) United States
(12) Patent Application Publication
(10) Pub. No.: US 2022/0356870 A1
(43) Pub. Date: Nov. 10, 2022

(54) DYNAMIC WIND TURBINE ROTATIONAL SPEED CONTROL

(71) Applicant: Noel Richard Potter, Bountiful, UT (US)

(72) Inventor: Noel Richard Potter, Bountiful, UT (US)

(21) Appl. No.: 17/313,280

(22) Filed: May 6, 2021

(51) Int. Cl. F03D 7/06; F03D 3/00; F03D 80/00; F03D 3/06

(52) U.S. Cl. CPC F03D 7/06; F03D 3/005; F03D 80/00; F03D 3/06; F05D 2270/02; F05D 2240/60

(57) ABSTRACT

Methods, systems, and devices for dynamic wind turbine rotational speed control are described. The method may include attaching a vane shaft to a support arm of the wind turbine, the vane shaft partially inserted into a cylindrical aperture of an airfoil of the wind turbine, rotating an airfoil around a vertical axis of the wind turbine, and controlling, via a torsion spring of the wind turbine, when a rear stop of the speed control assembly exerts a force on the airfoil to reduce the rotational speed of the wind turbine, where the torsion spring is configured to facilitate the rear stop to exert the force on the airfoil when a rotational speed of the wind turbine around the vertical axis exceeds a set rotational speed, where a portion of the vane shaft is inserted into a helical portion of the torsion spring.

### BACKGROUND

The following relates to a mechanical dynamic rotational speed control of a wind turbine, including dynamic wind turbine rotational speed control.

The present disclosure relates generally to generating electricity utilizing aerodynamic forces due to the interaction of a moving airfoil and the wind. A wind turbine may be configured to spin according to wind incident to the wind turbine. A wind turbine may be configured to spin on a horizontal axis or a vertical axis. Thus, a wind turbine may be configured to convert aerodynamic forces into electrical power. Some wind turbines, however, may become unstable in some circumstances (e.g., electrical system failures, etc.).

### SUMMARY

The described techniques relate to improved methods, systems, devices, and apparatuses that support dynamic wind turbine rotational speed control. Generally, the described techniques provide for dynamic wind turbine rotational speed control via a speed control assembly of a wind turbine.

A method for dynamic wind turbine rotational speed control by a speed control assembly of a wind turbine is described. The method may include attaching a vane shaft to a support arm of the wind turbine, the vane shaft partially inserted into a cylindrical aperture of an airfoil of the wind turbine, rotating an airfoil around a vertical axis of the wind turbine, and controlling, via a torsion spring of the wind turbine, when a rear stop of the speed control assembly exerts a rotational force on the airfoil, which in turn changes the pitch of the airfoil, lowering the aerodynamic forces. The change of the pitch of the airfoil and lowering of the aerodynamic forces in turn reduce the rotational speed of the wind turbine, where the torsion spring is configured to facilitate the rear stop to exert the rotational force on the airfoil when a rotational speed of the wind turbine around the vertical axis exceeds a set rotational speed, where a portion of the vane shaft is inserted into a helical portion of the torsion spring.

An apparatus for dynamic wind turbine rotational speed control by a speed control assembly of a wind turbine is described. A vane shaft is attached to a support arm of the wind turbine, the vane shaft partially inserted into a cylindrical aperture of an airfoil of the wind turbine, which rotates the airfoil around a vertical axis of the wind turbine, and control, via a torsion spring of the wind turbine, when a rear stop of the speed control assembly exerts a force on the airfoil, which changes its pitch which reduces the power generated which in turn reduces the rotational speed of the wind turbine, where the torsion spring is configured to facilitate the rear stop to exert the force on the airfoil when a rotational speed of the wind turbine around the vertical axis exceeds a set rotational speed, where a portion of the vane shaft is inserted into a helical portion of the torsion spring.

Another apparatus for dynamic wind turbine rotational speed control by a speed control assembly of a wind turbine is described. The apparatus may include means for attaching a vane shaft to a support arm of the wind turbine, the vane shaft partially inserted into a cylindrical aperture of an airfoil of the wind turbine, means for rotating an airfoil around a vertical axis of the wind turbine, and means for controlling, via a torsion spring of the wind turbine, when a rear stop of the speed control assembly exerts a rotational force on the airfoil, changing its pitch, to reduce the rotational speed of the wind turbine, where the torsion spring is configured to facilitate the rear stop to exert the rotational pitch changing force on the airfoil when a rotational speed of the wind turbine around the vertical axis exceeds a set rotational speed, where a portion of the vane shaft is inserted into a helical portion of the torsion spring.

Some examples of the method and apparatuses described herein may further include operations, features, means, or configurations for inserting an upper end of the torsion spring into an aperture of the rear stop, inserting a lower end of the torsion spring into an aperture of a support arm of the wind turbine assembly, and attaching the vane shaft to the support arm.

Some examples of the method and apparatuses described herein may further include operations, features, means, or configurations for attaching a rotation weight to the rear stop, where when the rotational speed of the wind turbine assembly does not exceed the set rotational speed, then the rotation weight may be at rest and the rear stop may be at rest against a rear brace attached to the support arm.

Some examples of the method and apparatuses described herein may further include operations, features, means, or configurations for configuring the rotation weight and the rear stop to rotate on an axis of the vane shaft towards a planar surface of a rear plate when the rotational speed of the wind turbine assembly exceeds the set rotational speed, where the rear plate extends from a surface of the airfoil.

In some examples of the method and apparatuses described herein, a tension of the torsion spring increases when the rotation weight and the rear stop rotate towards the rear plate due to centrifugal forces, and the rotation weight attaches to a planar surface of the rear stop.

In some examples of the method and apparatuses described herein, the torsion spring may be at rest when the rear stop may be at rest.

In some examples of the method and apparatuses described herein, at least the helical portion of the torsion spring may be positioned within a cylindrical sleeve of the wind turbine assembly, and the rear stop may be connected to or may be an extension of the cylindrical sleeve.

In some examples of the method and apparatuses described herein, the aperture of the airfoil may be positioned at a quarter chord point of the airfoil.

In some examples of the method and apparatuses described herein, the support arm extends from the vane shaft to a center shaft of the wind turbine, and the vertical axis of the wind turbine may be centered at the center shaft.

### BRIEF DESCRIPTION OF THE DRAWINGS

FIG. 1 illustrates an example of wind turbine system that supports dynamic wind turbine rotational speed control in accordance with aspects of the present disclosure.

FIG. 2 illustrates an example of a wind turbine system that supports dynamic wind turbine rotational speed control in accordance with aspects of the present disclosure.

FIG. 3 illustrates an example of a wind turbine system that supports dynamic wind turbine rotational speed control in accordance with aspects of the present disclosure.

FIG. 4 illustrates an example of a wind turbine system that supports dynamic wind turbine rotational speed control in accordance with aspects of the present disclosure.

FIG. 5 illustrates an example of a wind turbine system that supports dynamic wind turbine rotational speed control in accordance with aspects of the present disclosure.

FIG. 6 illustrates an example of a wind turbine system that supports dynamic wind turbine rotational speed control in accordance with aspects of the present disclosure.

FIG. 7 illustrates an example of a wind turbine system that supports dynamic wind turbine rotational speed control in accordance with aspects of the present disclosure.

FIG. 8 illustrates an example of a wind turbine system that supports dynamic wind turbine rotational speed control in accordance with aspects of the present disclosure.

FIGS. 9 and 10 show flowcharts illustrating methods that support dynamic wind turbine rotational speed control in accordance with aspects of the present disclosure.

### DETAILED DESCRIPTION

The apparatuses and methods described herein relate to dynamic rotational speed control of a wind turbine, including dynamic wind turbine rotational speed control so that a given wind turbine is prevented from generating potentially destructive forces.

A wind turbine assembly may include a turbine shaft configured to transmit mechanical power generated by the wind turbine assembly into electrical power. A support structure may connect to one or more vane shafts. Each vane shaft may include one or more vanes. Each vane may be configured to rotate freely about a vane shaft to the limits of a stop. Aerodynamic forces created by an interaction of air movement due to the velocity of the airfoil and the wind incident on a vane may cause the vane shaft to exert a force on the support structure, which force may be transferred to the turbine shaft, causing the turbine shaft to spin. The mechanical power of the turbine shaft spinning may be converted into electrical power via a generator/alternator assembly that is part of the wind turbine assembly.

A wind turbine that utilizes fixed pitch vanes must be rotationally accelerated to a revolutions per minute (RPM) where they may produce mechanical power because they produce only very negligible amounts of torque at low RPMs. As a result, benefits may be realized by an apparatus that may dynamically change the pitch of the vane so that the wind turbine may produce positive torque and power even at low RPMs.

In some cases, a wind turbine may include speed control assembly. The speed control assembly may include a rotating stop assembly configured to create a torque that limits a degree of rotation of an airfoil. The rotating stop assembly may be configured to rotate up against a rear plate of an airfoil, due to centrifugal forces, at a predetermined revolution per minute (RPM). Any additional wind turbine RPM above the predetermined RPM may cause the rotating stop assembly to rotate the respective airfoil to one or more positions that reduce the angle of attack of the airfoil. Reducing the angle of attack of the airfoil in turn reduces the power produced by the wind turbine, resulting in the RPM of the wind turbine to drop below the predetermined RPM. When the power produced by the wind turbine is reduced to be equal or relatively near the power it takes to rotate the wind turbine, potentially destructive forces on the wind turbine are reduced or avoided

Aspects of the disclosure are initially described in the context of a wind turbine system. Aspects of the disclosure are further illustrated by and described with reference to apparatus diagrams, system diagrams, and flowcharts that relate to dynamic wind turbine rotational speed control.

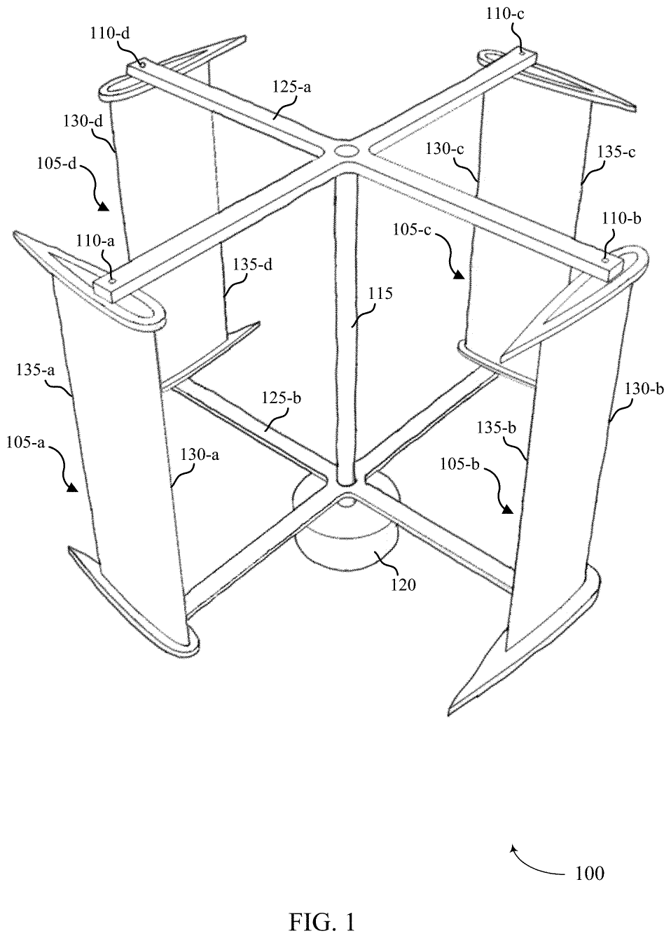

FIG. 1 illustrates an example of wind turbine assembly 100 (e.g., vertical axis wind turbine assembly) that supports dynamic rotational speed control of a respective wind turbine in accordance with aspects of the present disclosure. As illustrated, wind turbine assembly 100 may include one or more airfoils 105 (e.g., airfoil 105-a, airfoil 105-b, airfoil 105-c, airfoil 105-d), one or more vane shafts (e.g., vane shaft 110-a, vane shaft 110-b, vane shaft 110-c, vane shaft 110-d), a center shaft 115, base 120 (e.g., a motor, an alternator, a generator, etc.), and one or more support arms (e.g., support arm 125-a, support arm 125-b). In the illustrated example, an airfoil 105 may include an airfoil leading edge 130 (e.g., airfoil leading edge 130-a, airfoil leading edge 130-b, airfoil leading edge 130-c, airfoil leading edge 130-d) and an airfoil trailing edge 135 (e.g., airfoil trailing edge 135-a, airfoil trailing edge 135-b, airfoil trailing edge 135-c, airfoil trailing edge 135-d). In some cases, a respective vane shaft 110 may pass through a respective airfoil 105 at a quarter chord point of the respective airfoil 105. In some cases, a chord length may extend from a respective airfoil leading edge 130 to a respective trailing edge 135. Accordingly, the quarter chord point may be a point on a respective airfoil 105 at one quarter of the chord length from the respective leading edge 130.

In some examples, respective vane shafts 110 may be configured to enable respective airfoils 105 to rotate freely about the respective vane shafts 110. As illustrated, each airfoil 105 may be connected to a vane shaft 110. In some examples, each airfoil 105 may connect to upper support 102-a and/or lower support 102-b via the respective vane shafts 110. In some examples, the respective vane shafts 110 may include a shaft that runs from the top of each respective airfoil 105 at the upper support 102-a to the bottom of each airfoil 105 at the lower support 102-b. In some examples, wind turbine assembly 100 may include one or more vane stops. Vane stops may be attached to support arm 125-a and/or support arm 125-b to prevent a complete rotation of the respective airfoils 105 about the vane shafts 110. Preventing the complete rotation of respective airfoils 105 may enable the wind turbine assembly 100 to self-start. Self-starting may include center shaft 115 rotating without any other external input other than wind incident upon respective airfoils 105.

In some examples, wind incident on an airfoil 105 may be converted to mechanical power via center shaft 115. In some cases, base 120 may include an electrical motor, a generator, an alternator, and the like. Thus, in some examples the mechanical power generated by the rotation of center shaft 115 may be converted to electrical power via base 120.

In some examples, as illustrated the wind turbine assembly 100 may be configured to spin counter-clockwise. In some examples, the wind turbine assembly 100 may be configured to spin clockwise. In some examples, each airfoil 105 may include a rounded leading edge, followed by a sharp trailing edge (e.g., airfoil trailing edge 135). In some cases, each airfoil 105 may be in a teardrop shape. In some cases, each airfoil 105 may include a symmetric curvature or an asymmetric curvature.

In some examples, a leading edge 130 may include a rounded tip and the trailing edge 135 may include a sharp, pointed tip. The inner surface and/or outer surface may include a relatively flat surface. As depicted, the inner surface of an airfoil 105 faces towards the center shaft 115, while the outer surface faces away from the center shaft 115. In some examples, the inner surface and/or outer surface may include at least in part a flat surface according to existing airfoil shapes. Additionally, or alternatively, the inner surface and/or outer surface may include at least in part a curved surface according to existing airfoil shapes.

In some examples, wind turbine assembly 100 may include one or more rotating stop assemblies in accordance with aspects of the present disclosure. In some examples, a speed control assembly may include a torsion spring that connects to a support arm 125 (e.g., support arm 125-a or support arm 125-b) and to a rear stop that is attached to an airfoil 105. In some cases, at least one airfoil 105 may include a speed control assembly. In some cases, an airfoil may include two rotating stop assemblies (e.g., a first speed control assembly on an upper end of the airfoil 105 attached to support arm 125-a and a second speed control assembly on a lower end of the airfoil 105 attached to support arm 125-b).

In some cases, the speed control assembly may be configured to create a torque that limits a degree of rotation of an airfoil. The speed control assembly may be configured to rotate the speed control assembly up against a rear plate of an airfoil 105 at a predetermined revolution per minute (RPM). Any additional wind turbine RPM above the predetermined RPM may cause the speed control assembly to rotate the respective airfoil 105 to one or more positions that reduce the angle of attack of the airfoil 105. Reducing the angle of attack of the airfoil 105 in turn reduces the power produced by the wind turbine assembly 100, resulting in the RPM of the wind turbine assembly 100 to drop below the predetermined RPM. When the power produced by the wind turbine assembly 100 is reduced to be equal or relatively near the power it takes to rotate the wind turbine assembly 100, potentially destructive forces on the wind turbine assembly 100 are reduced or avoided.

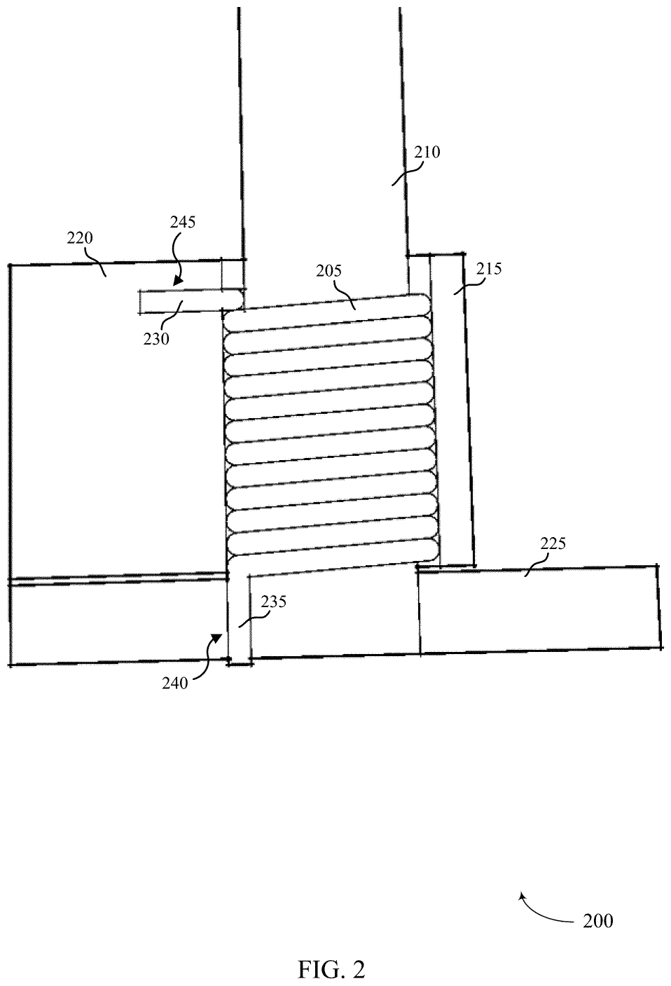

FIG. 2 illustrates an example of speed control assembly 200 that supports dynamic rotational speed control of a respective wind turbine in accordance with aspects of the present disclosure. In some examples, the speed control assembly 200 may implement aspects of wind turbine assembly 100. As illustrated, speed control assembly 200 may include a torsion spring 205, a vane shaft 210, a cylindrical sleeve 215, a rear stop 220, a support arm 225, an upper end 230 of torsion spring 205, and a lower end 235 of torsion spring 205, which may be examples of corresponding components as described herein. In some examples, vane shaft 210 may be an example of a vane shaft of FIG. 1 (e.g., vane shaft 110-a, vane shaft 110-b, vane shaft 110-c, vane shaft 110-d). In some examples, support arm 225 may be an example of a support arm of FIG. 1 (e.g., support arm 125-a or support arm 125-b). In some cases, support arm 225 may attach to a center shaft (e.g., center shaft 115).

In some examples, vane shaft 210 connects or attaches to support arm 225. In some cases, vane shaft 210 is inserted into an aperture of support arm 225. In some cases, vane shaft 210 may include or be inserted into a bearing (e.g., a bearing attached to or embedded into support arm 225) that reduces a rotational friction when vane shaft 210 rotates.

In the illustrated example, the torsion spring 205 may include a helical spring configured to exert a torque or rotary force. The torsion spring 205 may be configured to fit over (e.g., wrap around, wind around, or coil around) the vane shaft 210. In some cases, part of vane shaft 210 may pass through an airfoil (e.g., airfoil 105, through a cylindrical aperture of an airfoil that runs the length of the airfoil, passing through an airfoil at the quarter chord point of the airfoil, etc.). In the illustrated example, torsion spring 205 may wind up in the clockwise direction and unwind in the counter-clockwise direction. In some cases, torsion spring 205 may wind up in the counter-clockwise direction and unwind in the clockwise direction.

In some examples, the cylindrical sleeve 215 may be configured to fit over the vane shaft 210 (e.g., a portion of the vane shaft 210 passes through the cylindrical sleeve 215). In some cases, at least a portion of torsion spring 205 may be positioned within cylindrical sleeve 215 (e.g., the cylindrical sleeve 215 configured to fit over at least a portion of the torsion spring 205, at least a portion of the torsion spring inserted in the cylindrical sleeve 215). In the illustrated example, the lower end 235 of the torsion spring 205 may be inserted into or positioned within a portion of the support arm 225 (e.g., positioned into an aperture 240 of support arm 225). In the illustrated example, the upper end 230 of the torsion spring 205 may attach to the rear stop 220 (e.g., inserted into an aperture 245 of rear stop 220, placed in tension against the rear stop 220, etc.).

In some examples, the rear stop 220 may be a part of the cylindrical sleeve 215 (e.g., an extended portion of cylindrical sleeve 215, a planar extension of cylindrical sleeve 215, a panel or panel-like extension of cylindrical sleeve 215, etc.).

In some cases, the torsion spring 205 may have a resting position where the torsion spring 205 remains at rest when no external forces are acting on the torsion spring 205 (e.g., no forces winding up or unwinding torsion spring 205). When a force applied to the torsion spring 205 results in torsion spring 205 being wound up or unwound, the tension of torsion spring 205 may increase. As this force is removed or decreased, torsion spring 205 may rotate back to its resting position. Thus, one end of the torsion spring 205 (upper end 230) may be rotated in a first direction (e.g., winding up direction) with respect to the other end of the torsion spring 205 (e.g., lower end 235), causing the torsion spring 205 to increase tension, or to exert a torque in the opposite direction of the rotation (e.g., opposite the first direction, opposite the winding up direction). Similarly, one end of torsion spring 205 may be rotated in a second direction (e.g., unwinding direction) with respect to the other end of the torsion spring 205, causing torsion spring 205 to increase tension, or to exert a torque in the opposite direction of the rotation (e.g., opposite the second direction, opposite the unwinding direction).

In some examples, a rotation weight may be incorporated with the speed control assembly 200 (e.g., affixed to the speed control assembly 200, integrated with the speed control assembly 200, encapsulated within the speed control assembly 200). In some cases, the rotation weight incorporated with the speed control assembly 200 may create a torque (e.g., a clockwise torque in some configurations) on the speed control assembly 200 due to centrifugal forces on the associated wind turbine (e.g., centrifugal force directly or at least partially related to the RPM of the associated wind turbine).

As the rotation weight of the speed control assembly 200 creates the torque on the speed control assembly 200, the speed control assembly 200 may move rotationally around a vertical axis of vane shaft 210, and as the speed control assembly 200 moves rotationally (e.g., in the clockwise direction), the upper end 230 of torsion spring 205 may move with speed control assembly 200. As the upper end 230 of torsion spring 205 moves with speed control assembly 200 the tension of torsion spring 205 increases, and as the tension of torsion spring 205 increases, the torsion spring 205 increases a torque in the opposite direction (e.g., in the counter-clockwise direction).

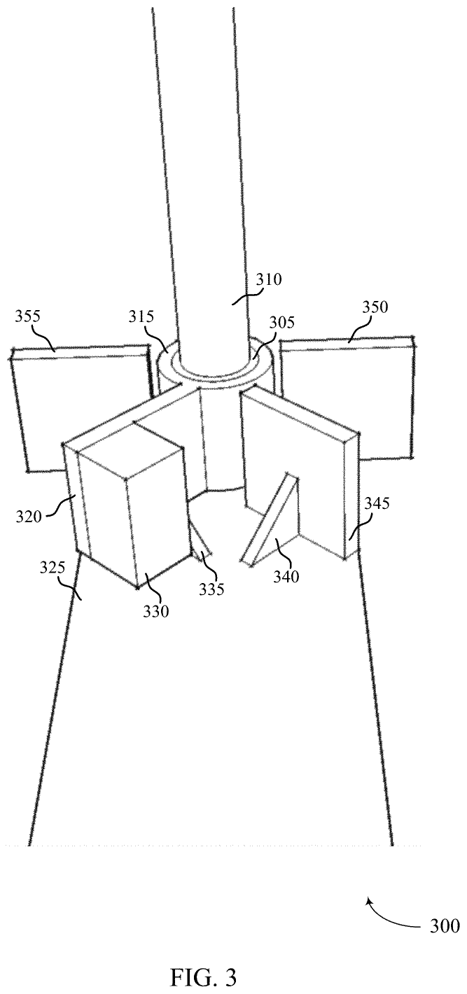

The strength of the counter-torque of the torsion spring 205 (e.g., spring force, torsion strength, tensile strength) may be selected and the torsion spring 205 configured to enable the speed control assembly 200 to rotate up against a rear plate (e.g., rear plate 355 of FIG. 3) connected to an airfoil of the vane shaft 210 as a rotational speed of an associated wind turbine assembly approaches, reaches, or exceeds a predetermined RPM (e.g., 300 RPM, or 400 RPM, or 500 RPM, etc.). The potential for destructive forces on the wind turbine assembly increase as the wind turbine assembly rotational speed increases (e.g., as the wind turbine assembly rotational speed approaches, reaches, or exceeds the predetermined RPM).

After the speed control assembly 200 rotates up against the rear plate due to centrifugal forces, any additional wind turbine RPM above the wind turbine RPM that rotated the speed control assembly 200 up against the rear plate may cause the speed control assembly 200 to rotationally move the rear plate. Because the rear plate is connected or attached to the airfoil, as the rear plate rotates, the airfoil rotates, and as the airfoil rotates the angle of attack changes. In some cases, the speed control assembly 200 may rotate the airfoil to one or more positions (e.g., of a range of angles of attack) that reduce the angle of attack of the airfoil. Reducing the angle of attack of the airfoil in turn reduces the power produced by the wind turbine, resulting in the RPM of the wind turbine to drop below the predetermined RPM. When the power produced by the wind turbine equals or is relatively near the power it takes to rotate the wind turbine, potentially destructive forces on the wind turbine assembly are reduced or avoided. A wind turbine assembly without the speed control assembly 200 could reach RPM speeds that would have a potentially destructive effect on the wind turbine assembly, possibly resulting in catastrophic damage to the wind turbine assembly as well as nearby objects or people, etc. Accordingly, the speed control assembly 200 protects at least the associated wind turbine assembly (e.g., an example of wind turbine assembly 100) by limiting the RPM up to which the wind turbine assembly may safely operate.

FIG. 3 illustrates an example of speed control assembly 300 that supports dynamic rotational speed control of a respective wind turbine in accordance with aspects of the present disclosure. In some examples, the speed control assembly 300 may implement aspects of a wind turbine assembly. In some cases, the wind turbine assembly (e.g., wind turbine assembly 100) may include the speed control assembly 300.

As illustrated, speed control assembly 300 may include torsion spring 305, vane shaft 310, cylindrical sleeve 315, rear stop 320, support arm 325, rotation weight 330, rear brace 335, front brace 340, front stop 345, front plate 350, and rear plate 355, one or more of which may be examples of corresponding components as described herein.

In the illustrated example, front plate 350 may attach to (e.g., be inserted into) a bottom surface of a given airfoil (e.g., an airfoil 105) between vane shaft 310 and a leading edge of the airfoil (e.g., airfoil leading edge 130). In some examples, rear plate 355 may attach to (e.g., be inserted into) the bottom surface of the airfoil between vane shaft 310 and a trailing edge of the airfoil (e.g., airfoil trailing edge 135). Based on these respective attachments, as the given airfoil rotates the front plate 350 and rear plate 355 may rotate with the airfoil.

In the illustrated example, front stop 345 may attach to the support arm 325. In some cases, front brace 340 may attach to the support arm 325. In some cases, rear brace 335 may attach to the support arm 325. In some cases, rear stop 320 may attach to or extend from the cylindrical sleeve 315. In some examples, rotation weight 330 may attach to the rear stop 320. In some cases, rear stop 320 may be spring loaded based on torsion spring 305 positioned within cylindrical sleeve 315. In some cases, rear stop 320 may be configured to rotate (e.g., in clockwise or counter-clockwise direction based on configuration). In some cases, cylindrical sleeve 315 and rear stop 320 may be configured to rotate on vane shaft 310 between the fixed position of rear brace 335 on support arm 325 and the rotatable position of rear plate 355 according to the position of the airfoil to which front plate 350 and rear plate 355 attach.

In the illustrated example, the rear stop 320 stops a rotation of the airfoil (e.g., the airfoil to which front plate 350 and rear plate 355 attach) in the counter-clockwise direction (e.g., when the rear stop 320 is at rest against the rear brace 335). In the illustrated example, the front stop 345 stops a rotation of the airfoil in the clockwise direction. In the illustrated example, the front stop 345 is fixed in place against the front brace 340, while the rear stop 320 may rotate around an axis of the vane shaft 310.

In some examples, the torsion spring 305 may wrap or wind around the vane shaft 310 (e.g., situated between the vane shaft 310 and the cylindrical sleeve 315). In some examples, the torsion spring 305 may be a metal coil (e.g., steel coil, etc.). In some examples, a lower end of the torsion spring 305 may be attached to or inserted into the support arm 325 (e.g., lower end 235 of the torsion spring 205 inserted into aperture 240 of support arm 225). In some examples, an upper end of torsion spring 305 may be attached to, inserted into the rear stop 320 (e.g., upper end 230 of torsion spring 205 inserted into aperture 245 of rear stop 220).

In the illustrated example, an upper end of torsion spring 305 (e.g., upper end 230) may be inserted into rear stop 320, while a lower end of torsion spring 305 may be inserted into or positioned within a portion of the support arm 325. Thus, rotating rear stop 320 and cylindrical sleeve 315 towards rear plate 355 may increase a tension of torsion spring 305. In some cases, the rear stop 320 may be at rest against the rear brace 335 during certain rotational speeds of the given wind turbine assembly (e.g., below a threshold rotational speed of the given wind turbine assembly). In the illustrated example, the torsion spring 305 may be wound up or unwound from a resting position of the torsion spring 305 when the rear stop 320 is at rest against the rear brace 335. In some examples, the torsion spring 305 may be set at tension when the rear stop 320 is at rest against the rear brace 335. In some cases, the torsion spring 305 may push the rear stop 320 and rotation weight 330 against the rear brace 335.

Without adjusting the lower end of torsion spring 305, the resting position of the upper end of torsion spring 305 (e.g., the position of the upper end of torsion spring 305 where there is no winding up or unwinding of torsion spring 305) may be up to ninety degrees counter-clockwise relative to the position of the upper end of torsion spring 305 as indicated by the position of the rear stop 320. Said another way, keeping the lower end of torsion spring 305 in place and removing all obstructions (e.g., rear brace 335, front brace 340, front stop 345, etc.), the upper end of torsion spring 305 may cause rear stop 320 to rotate up to ninety degrees counter-clockwise in the illustrated example before the upper end of torsion spring 305 comes to rest at a neutral position (e.g., no winding up or unwinding of torsion spring 305 with respect to the neutral position). Accordingly, a torque of the upper end of torsion spring 305 inserted into rear stop 320 may push rear stop 320 into rear brace 335.

In the illustrated example, as a rotational speed of an associated wind turbine assembly approaches or reaches, or in some cases exceeds, a predetermined RPM (e.g., 300 RPM, or 400 RPM, or 500 RPM, etc.) or is at rest (e.g., no force of the wind turbine assembly caused by wind or a force external to the wind turbine assembly is acting on the wind turbine assembly), the torsion spring 305 may rest against (e.g., apply a force to, put tension against) the rear brace 335. In some examples, torsion spring 305 may be set against rear brace 335 under tension (e.g., the lower end or the upper end of torsion spring 305, or both, rotated some distance beyond the resting position of torsion spring 305 in a winding or unwinding rotational direction).

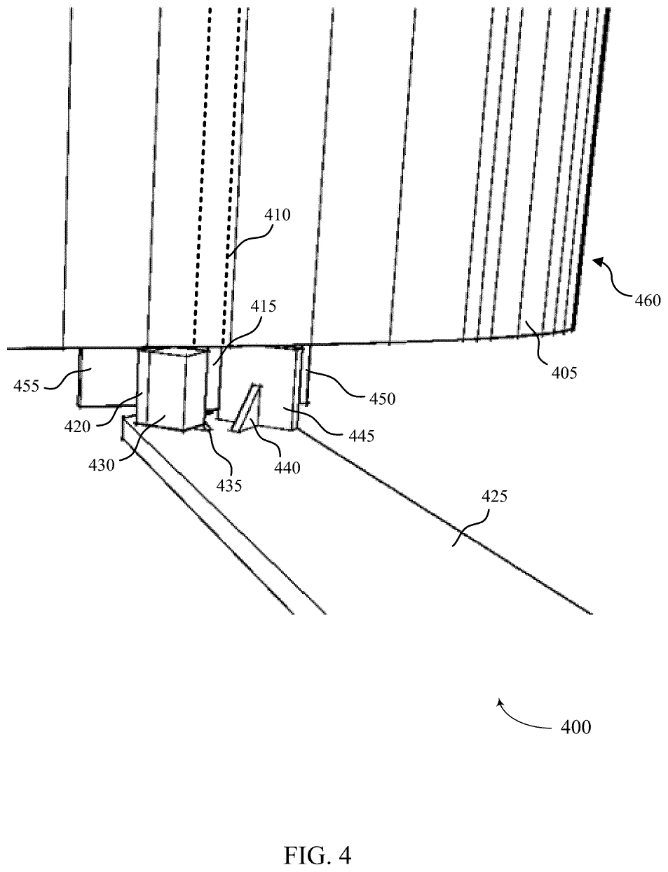

FIG. 4 illustrates an example of speed control assembly 400 that supports dynamic rotational speed control of a respective wind turbine in accordance with aspects of the present disclosure. In some examples, the speed control assembly 400 may implement aspects of a wind turbine assembly. In some cases, a wind turbine assembly (e.g., wind turbine assembly 100) may include the speed control assembly 400.

As illustrated, speed control assembly 400 may include airfoil 405, vane shaft 410, cylindrical sleeve 415, rear stop 420, support arm 425, rotation weight 430, rear brace 435, front brace 440, front stop 445, front plate 450, and rear plate 455, one or more of which may be examples of corresponding components as described herein.

In some examples, vane shaft 410 may pass through airfoil 405 (e.g., at the quarter-chord point of airfoil 405). In some cases, the vane shaft 410 may attach to support arm 425. In some cases, support arm 425 may attach to a center shaft (e.g., center shaft 115 of FIG. 1). In some cases, the vane shaft 410 may pass through cylindrical sleeve 415. In some cases, a torsion spring may be inserted within cylindrical sleeve 415 (e.g., torsion spring 205 of FIG. 2). In the illustrated example, rear stop 420 may attach to (e.g., extend from) cylindrical sleeve 415. In some examples, rotation weight 430 may attach to rear stop 420.

In the illustrated example, when a rotational speed of an associated wind turbine assembly is at rest (e.g., no force acting on the wind turbine assembly caused by wind or any force external to the wind turbine assembly), or is rotating at a speed between at rest and up to a predetermined RPM (e.g., 300 RPM, or 400 RPM, or 500 RPM, etc.), or approaches or reaches (or is within a relatively small margin of) the predetermine RPM, then the torsion spring 305 may rest or remain resting against (e.g., apply a force to, put tension against) the rear brace 335. In some cases, the relatively small margin may be between 0 and 10 RPM of the predetermined RPM, or within 5% of the predetermined RPM, or within 10% of the predetermined RPM, etc. In some examples, torsion spring 305 may be set against rear brace 335 under tension (e.g., rotated some distance beyond the resting position of torsion spring 305 in a winding or unwinding rotational direction).

In some examples, speed control assembly 400 may depict one or more aspects of speed control assembly 300 in relation to airfoil 405. In some cases, the rear stop 420 may be at rest against the rear brace 435 during certain rotational speeds of the given wind turbine assembly (e.g., below a threshold rotational speed of the given wind turbine assembly).

In some examples, airfoil 405 may be positioned at some rotation (e.g., 270 degrees) around a center shaft of a wind turbine. In the illustrated example, the airfoil 405 may be on the windward side of a wind turbine (e.g., wind is incident on the wind turbine at 270 degrees, and exits the wind turbine at 90 degrees). When the angle of attack of the airfoil 405 is 0 degrees, the airfoil 405 (e.g., from tail to leading edge 460) may be perpendicular to support arm 425 (e.g., perpendicular to support arm 425 from where support arm 425 attaches to a center shaft to where support arm 425 attaches to vane shaft 410).

In the illustrated example, the angle of attack of the airfoil 405 may be angled towards the center shaft of the wind turbine (e.g., 14 to 16 degrees towards the center shaft of the wind turbine relative to the airfoil 405 being perpendicular to support arm 425), where the leading edge 460 of the airfoil 405 may be rotated (e.g., at, within, or relatively near 14 to 16 degrees) towards the center shaft of the associated wind turbine.

In the illustrated example, the tip speed ratio may be multiple times the speed of the wind incident on the wind turbine (e.g., at or relatively near 4 times the speed of the wind incident on the wind turbine), where the tip speed ratio refers to a ratio between the wind speed and the speed of the leading edge 460 of airfoil 405. In some examples, the illustrated angle of attack of (e.g., 14 to 16 degrees) may correspond to a tip speed ratio of (e.g., tip speed ratio of 4 or relatively near 4).

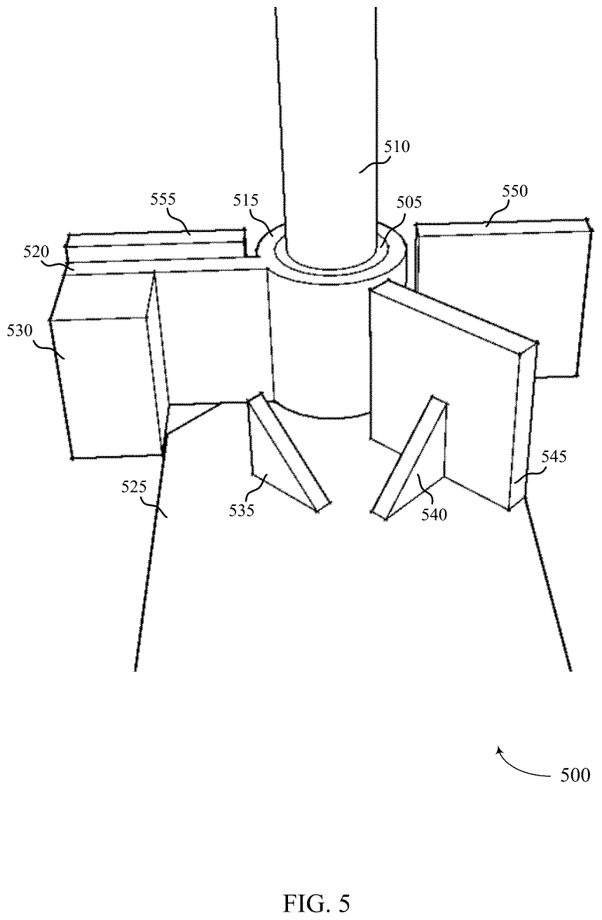

FIG. 5 illustrates an example of speed control assembly 500 that supports dynamic rotational speed control of a respective wind turbine in accordance with aspects of the present disclosure. In some examples, the speed control assembly 500 may implement aspects of a wind turbine assembly. In some cases, the wind turbine assembly (e.g., wind turbine assembly 100) may include the speed control assembly 500.

As illustrated, speed control assembly 500 may include torsion spring 505, vane shaft 510, cylindrical sleeve 515, rear stop 520, support arm 525, rotation weight 530, rear brace 535, front brace 540, front stop 545, front plate 550, and rear plate 555, one or more of which may be examples of corresponding components as described herein.

In some examples, rear stop 520 may be configured to rotate. In some cases, cylindrical sleeve 515 and rear stop 520 may be configured to rotate on vane shaft 510 between the fixed position of rear brace 535 on support arm 525 and the rotatable position of rear plate 555 according to the position of the airfoil to which front plate 550 and rear plate 555 attach. In the illustrated example, an upper end of torsion spring 505 (e.g., upper end 230) may be inserted into rear stop 520, while a lower end of torsion spring 505 may be inserted into or positioned within a portion of the support arm 525. Thus, rotating rear stop 520 and cylindrical sleeve 515 towards rear plate 555 may increase a tension of torsion spring 505.

In the illustrated example, the rear stop 520 may rotate around an axis of the vane shaft 510 in the clockwise direction. In some examples, as a rotational speed of an associated wind turbine assembly approaches, reaches, or exceeds a predetermined RPM (e.g., 300 RPM, or 400 RPM, or 500 RPM), the angle of attack of an associated airfoil (e.g., an airfoil attached to front plate 550 and rear plate 555) may be angled towards the center shaft of the wind turbine (e.g., 14 to 16 degrees towards the center shaft of the wind turbine), front plate 550 may be rotated (e.g., 14 to 16 degrees) towards the center shaft of the associated wind turbine assembly, and rear plate 555 may be rotated (e.g., 14 to 16 degrees) away from the center shaft of the associated wind turbine assembly.

In the illustrated example, as a rotational speed of an associated wind turbine assembly approaches, reaches, or exceeds a predetermined RPM, the centrifugal force on the rotation weight 530 may increase. As the centrifugal forces on the rotation weight 530 increase, the increasing centrifugal forces on rotation weight 530 may overcome the counter-clockwise force (e.g., counter-torque) of the torsion spring 505, resulting in the rotation weight 530 rotating in the clockwise direction (e.g., towards rear plate 555, away from rear brace 535).

In some examples, as a rotational speed of an associated wind turbine assembly drops below a predetermined RPM, or continues to decrease below a predetermined RPM, the centrifugal force on the rotation weight 530 may decrease. As the centrifugal forces on the rotation weight 530 decrease, the counter-clockwise force (e.g., counter-torque) of the torsion spring 505 may overcome the decreasing centrifugal forces on rotation weight 530, resulting in the rotation weight 530 rotating back in the counter-clockwise direction (e.g., away from rear plate 555, towards rear brace 535).

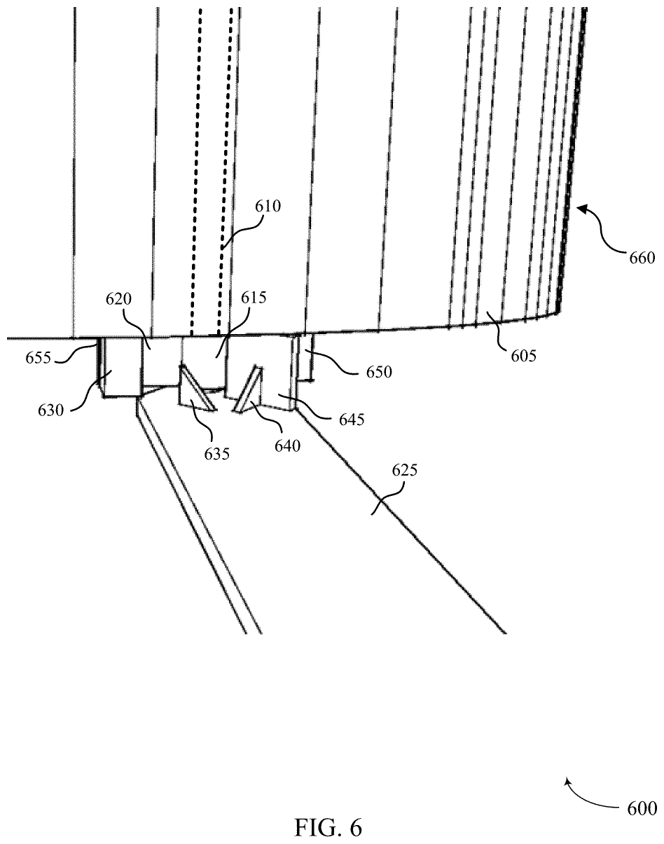

FIG. 6 illustrates an example of speed control assembly 600 that supports dynamic rotational speed control of a respective wind turbine in accordance with aspects of the present disclosure. In some examples, the speed control assembly 600 may implement aspects of a wind turbine assembly. In some cases, a wind turbine assembly (e.g., wind turbine assembly 100) may include the speed control assembly 600.

As illustrated, speed control assembly 600 may include airfoil 605, vane shaft 610, cylindrical sleeve 615, rear stop 620, support arm 625, rotation weight 630, rear brace 635, front brace 640, front stop 645, front plate 650, and rear plate 655, one or more of which may be examples of corresponding components as described herein.

In some examples, vane shaft 610 may pass through airfoil 605 (e.g., at the quarter-chord point of airfoil 605). In some cases, the vane shaft 610 may attach to support arm 625. In some cases, support arm 625 may attach to a center shaft (e.g., center shaft 115). In some cases, the vane shaft 610 may pass through cylindrical sleeve 615. In some cases, a torsion spring may be inserted within cylindrical sleeve 615 (e.g., torsion spring 205 of FIG. 2). In the illustrated example, rear stop 620 may attach to (e.g., extend from) cylindrical sleeve 615. In some examples, rotation weight 630 may attach to rear stop 620.

In some examples, rear stop 620 may be configured to rotate. In some cases, cylindrical sleeve 615 and rear stop 620 may be configured to rotate on vane shaft 610 between the fixed position of rear brace 635 on support arm 625 and the rotatable position of rear plate 655, the rotatable position of rear plate 655 being positioned according to the position of the airfoil 605 to which rear plate 655 attaches.

In the illustrated example, the rear stop 620 may rotate around an axis of the vane shaft 610 in the clockwise direction as a rotational speed of airfoil 605 increases (e.g., as centrifugal forces on speed control assembly 600 increase). In the illustrated example, an upper end of torsion spring may be inserted into rear stop 620, while a lower end of torsion spring may be inserted into or positioned within a portion of the support arm 625. Thus, rotating rear stop 620 and cylindrical sleeve 615 towards rear plate 655 may increase a tension of torsion spring.

In the illustrated example, as a rotational speed of an associated wind turbine assembly approaches, reaches, or exceeds a predetermined RPM (e.g., 300 RPM, or 400 RPM, or 600 RPM), the angle of attack of airfoil 605 may increase (e.g., the leading edge 660 of the airfoil 605 rotates 14 to 16 degrees towards the center shaft of the associated wind turbine), front plate 650 may be rotated (e.g., 14 to 16 degrees) towards the center shaft of the associated wind turbine assembly, and rear plate 655 may be rotated (e.g., 14 to 16 degrees) away from the center shaft of the associated wind turbine assembly.

In the illustrated example, as a rotational speed of an associated wind turbine assembly approaches, reaches, or exceeds a predetermined RPM, centrifugal forces on the rotation weight 630 may increase. As the centrifugal forces on the rotation weight 630 increase, the increasing centrifugal forces on rotation weight 630 may overcome the counter-clockwise force (e.g., counter-torque) of the torsion spring, resulting in the rotation weight 630, and the rear stop 620 attached to rotation weight 630, to rotate in the clockwise direction (e.g., towards rear plate 655, away from rear brace 635).

In some examples, as a rotational speed of an associated wind turbine assembly drops below a predetermined RPM, or continues to decrease below a predetermined RPM, the centrifugal force on the rotation weight 630 may decrease. As the centrifugal forces on the rotation weight 630 decrease, the counter-clockwise force (e.g., counter-torque) of the torsion spring may overcome the decreasing centrifugal forces on rotation weight 630, resulting in the rotation weight 630 and rear stop 620 to rotate back in the counter-clockwise direction (e.g., away from rear plate 655, towards rear brace 635).

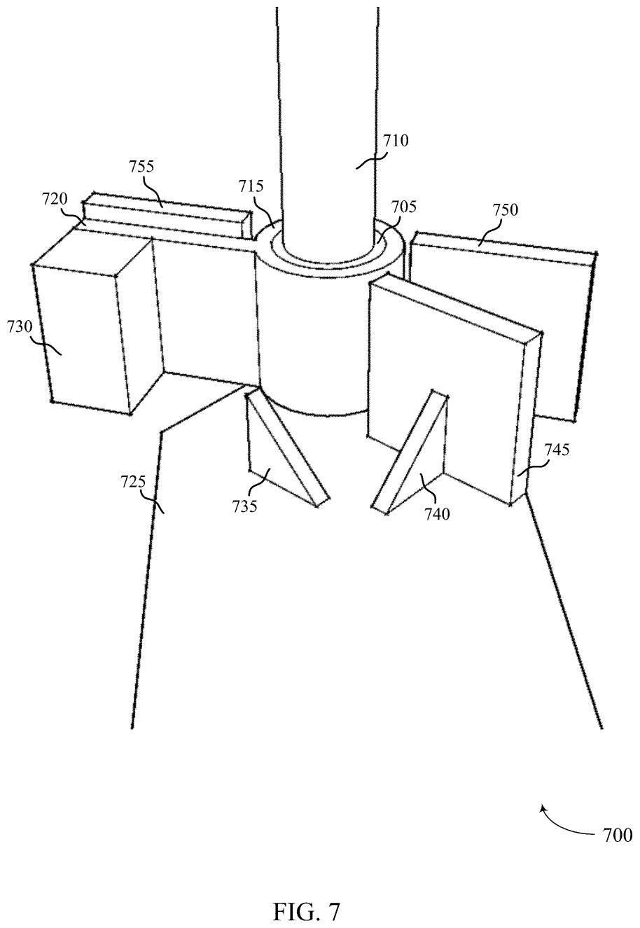

FIG. 7 illustrates an example of speed control assembly 700 that supports dynamic rotational speed control of a respective wind turbine in accordance with aspects of the present disclosure. In some examples, the speed control assembly 700 may implement aspects of a wind turbine assembly. In some cases, the wind turbine assembly (e.g., wind turbine assembly 100) may include the speed control assembly 700.

As illustrated, speed control assembly 700 may include torsion spring 705, vane shaft 710, cylindrical sleeve 715, rear stop 720, support arm 725, rotation weight 730, rear brace 735, front brace 740, front stop 745, front plate 750, and rear plate 755, one or more of which may be examples of corresponding components as described herein.

In some examples, rear stop 720 may be configured to rotate. In some cases, cylindrical sleeve 715 and rear stop 720 may be configured to rotate on vane shaft 710 between the fixed position of rear brace 735 on support arm 725 and the rotatable position of rear plate 755 according to the position of the airfoil to which front plate 750 and rear plate 755 attach. In the illustrated example, an upper end of torsion spring 705 (e.g., upper end 230) may be inserted into rear stop 720, while a lower end of torsion spring 705 may be inserted into or positioned within a portion of the support arm 725. Thus, rotating rear stop 720 and cylindrical sleeve 715 towards rear plate 755 may increase a tension of torsion spring 705.

In the illustrated example, the rear stop 720 may rotate around an axis of the vane shaft 710 in the clockwise direction. In some examples, as a rotational speed of an associated wind turbine assembly approaches, reaches, or exceeds a predetermined RPM (e.g., 300 RPM, or 400 RPM, or 700 RPM), the angle of attack of an associated airfoil (e.g., an airfoil attached to front plate 750 and rear plate 755) may be angled towards the center shaft of the wind turbine (e.g., 14 to 16 degrees towards the center shaft of the wind turbine), front plate 750 may be rotated (e.g., 14 to 16 degrees) towards the center shaft of the associated wind turbine assembly, and rear plate 755 may be rotated (e.g., 14 to 16 degrees) away from the center shaft of the associated wind turbine assembly.

In the illustrated example, as a rotational speed of an associated wind turbine assembly approaches, reaches, or exceeds a predetermined RPM, the centrifugal force on the rotation weight 730 may increase. As the centrifugal forces on the rotation weight 730 increase, the increasing centrifugal forces on rotation weight 730 may overcome the counter-clockwise force (e.g., counter-torque) of the torsion spring 705, resulting in the rotation weight 730 rotating in the clockwise direction (e.g., towards rear plate 755, away from rear brace 735).

In the illustrated example, rear stop 720 may rotate up to rear plate 755 as the centrifugal forces on the rotation weight 730 increase (e.g., as a rotational speed of an associated wind turbine assembly increases). In some cases, rear stop 720 may come in contact with rear plate 755 as the centrifugal forces on the rotation weight 730 increase (e.g., rear stop 720 may rotate some number of degrees (e.g., 40 to 50 degrees) away from rear brace 735 before coming in contact with rear plate 755 when rear plate 755 is rotated 14 to 16 degrees away from the center shaft relative to rear plate 755 being perpendicular to support arm 725).

In some examples, rear stop 720 may exert a force on rear plate 755 as the centrifugal forces on the rotation weight 730 increase. In some cases, rear stop 720 may rotate rear plate 755, based on the exerted force, more than 16 degrees or at least 17 degrees away from the center shaft. In some cases, an airfoil attached to front plate 750 and rear plate 755 may be rotated more than some number of degrees (e.g., 7 to 14 degrees) relative to the airfoil being perpendicular to support arm 725.

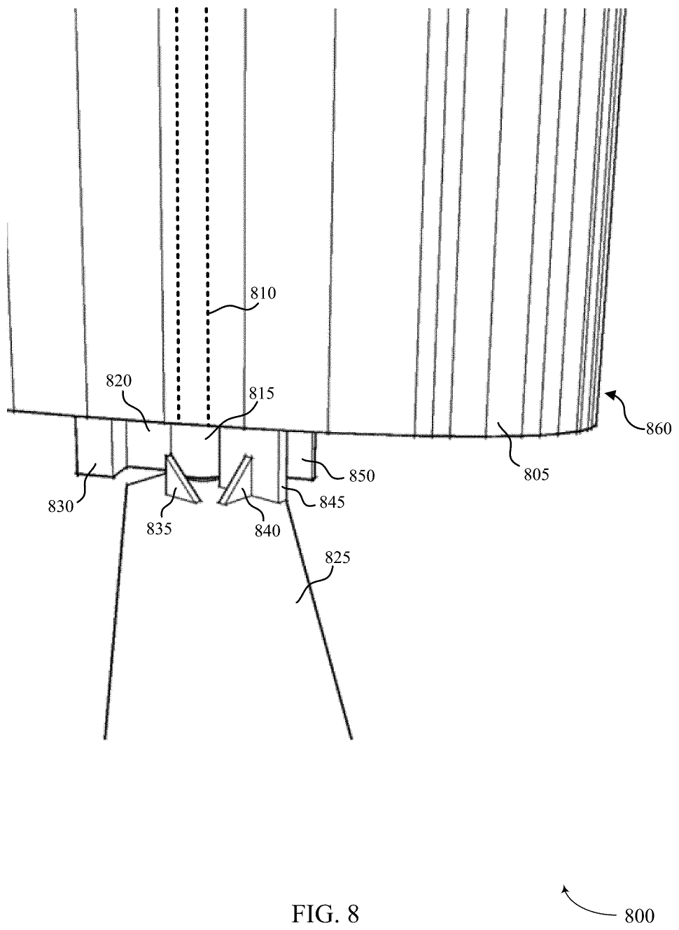

FIG. 8 illustrates an example of speed control assembly 800 that supports dynamic rotational speed control of a respective wind turbine in accordance with aspects of the present disclosure. In some examples, the speed control assembly 800 may implement aspects of a wind turbine assembly. In some cases, a wind turbine assembly (e.g., wind turbine assembly 100) may include the speed control assembly 800.

As illustrated, speed control assembly 800 may include airfoil 805, vane shaft 810, cylindrical sleeve 815, rear stop 820, support arm 825, rotation weight 830, rear brace 835, front brace 840, front stop 845, front plate 850, and rear plate 855, one or more of which may be examples of corresponding components as described herein.

In some examples, vane shaft 810 may pass through airfoil 805 (e.g., at the quarter-chord point of airfoil 805). In some cases, the vane shaft 810 may attach to support arm 825. In some cases, support arm 825 may attach to a center shaft (e.g., center shaft 115). In some cases, the vane shaft 810 may pass through cylindrical sleeve 815. In some cases, a torsion spring may be inserted within cylindrical sleeve 815 (e.g., torsion spring 205 of FIG. 2). In the illustrated example, rear stop 820 may attach to (e.g., extend from) cylindrical sleeve 815. In some examples, rotation weight 830 may attach to rear stop 820.

In some examples, rear stop 820 may be configured to rotate. In some cases, cylindrical sleeve 815 and rear stop 820 may be configured to rotate on vane shaft 810 between the fixed position of rear brace 835 on support arm 825 and the rotatable position of rear plate 855, the rotatable position of rear plate 855 being positioned according to the position of the airfoil 805 to which front plate 850 and rear plate 855 attach. In the illustrated example, an upper end of torsion spring may be inserted into rear stop 820, while a lower end of torsion spring may be inserted into or positioned within a portion of the support arm 825. Thus, rotating rear stop 820 and cylindrical sleeve 815 towards rear plate 855 may increase a tension of torsion spring.

In the illustrated example, the rear stop 820 may rotate around an axis of the vane shaft 810 in the clockwise direction as a rotational speed of airfoil 805 increases (e.g., as centrifugal forces on speed control assembly 800 increase). In some cases, as a rotational speed of an associated wind turbine assembly approaches, reaches, or exceeds a predetermined RPM (e.g., 300 RPM, or 400 RPM, or 600 RPM), the angle of attack of airfoil 805 may change (e.g., the leading edge 860 of the airfoil 805 rotates 7 to 14 degrees towards the center shaft of the associated wind turbine), front plate 850 may be rotated (e.g., 7 to 14 degrees) towards the center shaft of the associated wind turbine assembly, and rear plate 855 may be rotated (e.g., 7 to 14 degrees) away from the center shaft of the associated wind turbine assembly.

In the illustrated example, as a rotational speed of an associated wind turbine assembly approaches, reaches, or exceeds a predetermined RPM, centrifugal forces on the rotation weight 830 may increase. As the centrifugal forces on the rotation weight 830 increase, the increasing centrifugal forces on rotation weight 830 may overcome the counter-clockwise force (e.g., counter-torque) of the torsion spring, resulting in the rotation weight 830, and the rear stop 820 attached to rotation weight 830, to rotate in the clockwise direction (e.g., towards rear plate 855, away from rear brace 835).

In the illustrated example, front stop 845 may stop front plate 850 from rotating more than some angle of rotation. In some cases, front stop 845 may stop front plate 850 from rotating more than 45 degrees towards front plate 850 relative to front plate 850 being perpendicular to support arm 825. In some cases, front stop 845 may stop front plate 850 from rotating more than 90 degrees towards front plate 850 relative to rear plate 855 being at rest against rear brace 835.

In some examples, rear stop 820 may exert a force on rear plate 855 as the centrifugal forces on the rotation weight 830 increase. In some cases, rear stop 820 may rotate rear plate 855, based on the exerted force, more than some number of degrees (e.g., 7 to 12 degrees) away from the center shaft relative to rear stop 820 being perpendicular to support arm 825. In some cases, as rear plate 855 is rotated more than some number of degrees (e.g., 7 to 12 degrees), airfoil 805, which is attached to front plate 850 and rear plate 855, may be rotated some number of degrees (e.g., 7 to 12 degrees) relative to airfoil 805 being perpendicular to support arm 825 (e.g., the leading edge 860 of the airfoil 805 may be rotated 7 to 12 degrees towards the center shaft of the associated wind turbine). On the up-wind side of the wind turbine, a change in the angle of attack (e.g., 7 to 12 degrees) may add to the angle of attack, which may increase the drag and reduce the power generated on that half of the wind turbine. On the down-wind side of the wind turbine the change in angle of attack (e.g., 7 to 12 degrees) may decrease the angle of attack, eliminating the aerodynamic forces, which reduces the power generated on that half of the wind turbine. As the lift being generated by airfoil 805 is reduced or eliminated, the rotational speed of the wind turbine assembly associated with speed control assembly 800 is reduced (e.g., drops below the predetermined RPM), and as the rotational speed is reduced, the potential for destructive forces is decreased. Accordingly, the speed control assembly 800 protects at least the associated wind turbine assembly (e.g., an example of wind turbine assembly 100) by limiting the RPM up to which the wind turbine assembly may safely operate.

Reference to a first object being “attached” to a second object may refer to adhesively affixing the first object to the second object, or using one or more fasteners to fasten the first object to the second object, or inserting at least a portion of the first object into a cavity of the second object, or inserting at least a portion of the second object into a cavity of the first object, or the first object being an extension of the second object, or the second object being an extension of the first object, or any combination thereof.

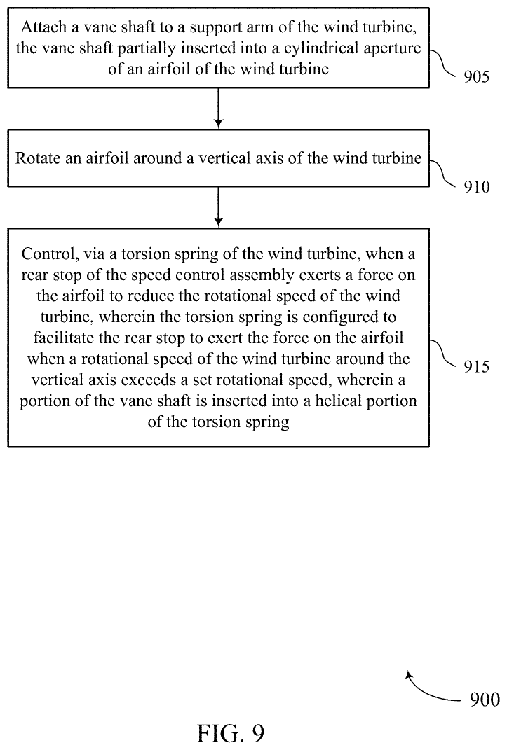

FIG. 9 shows a flowchart illustrating a method 900 that supports dynamic wind turbine rotational speed control in accordance with aspects of the present disclosure. The operations of the method 900 may be implemented by wind turbine device or its components as described herein. For example, the operations of the method 900 may be performed by a wind turbine device as described with reference to FIGS. 1 through 8. In some examples, a wind turbine device may mechanically control the functional elements of the wind turbine device to perform the described functions. Additionally or alternatively, the wind turbine device may perform aspects of the described functions using special-purpose hardware.

At 905, the method may include attaching a vane shaft to a support arm of the wind turbine, the vane shaft partially inserted into a cylindrical aperture of an airfoil of the wind turbine. The operations of 905 may be performed in accordance with examples as disclosed herein. In some examples, aspects of the operations of 905 may be performed by a speed control assembly of a wind turbine as described with reference to FIGS. 1 through 8.

At 910, the method may include rotating an airfoil around a vertical axis of the wind turbine. The operations of 910 may be performed in accordance with examples as disclosed herein. In some examples, aspects of the operations of 910 may be performed by a speed control assembly of a wind turbine as described with reference to FIGS. 1 through 8.

At 915, the method may include controlling, via a torsion spring of the wind turbine, when a rear stop of the speed control assembly exerts a force on the airfoil to reduce the rotational speed of the wind turbine, where the torsion spring is configured to facilitate the rear stop to exert the force on the airfoil when a rotational speed of the wind turbine around the vertical axis exceeds a set rotational speed, where a portion of the vane shaft is inserted into a helical portion of the torsion spring. The operations of 915 may be performed in accordance with examples as disclosed herein. In some examples, aspects of the operations of 915 may be performed by a speed control assembly of a wind turbine as described with reference to FIGS. 1 through 8.

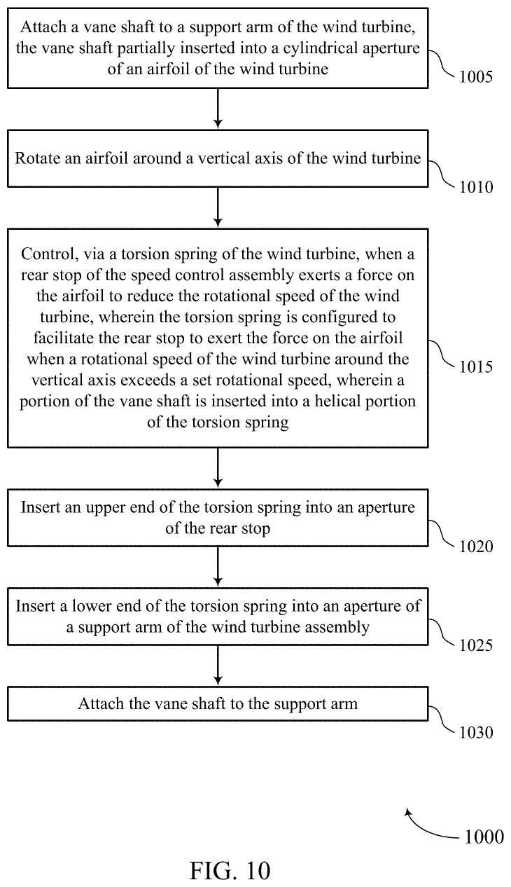

FIG. 10 shows a flowchart illustrating a method 1000 that supports dynamic wind turbine rotational speed control in accordance with aspects of the present disclosure. The operations of the method 1000 may be implemented by a wind turbine device or its components as described herein. For example, the operations of the method 1000 may be performed by a wind turbine device as described with reference to FIGS. 1 through 8. In some examples, a wind turbine device may mechanically control the functional elements of the wind turbine device to perform the described functions. Additionally or alternatively, the wind turbine device may perform aspects of the described functions using special-purpose hardware.

At 1005, the method may include attaching a vane shaft to a support arm of the wind turbine, the vane shaft partially inserted into a cylindrical aperture of an airfoil of the wind turbine. The operations of 1005 may be performed in accordance with examples as disclosed herein. In some examples, aspects of the operations of 1005 may be performed by a speed control assembly of a wind turbine as described with reference to FIGS. 1 through 8.

At 1010, the method may include rotating an airfoil around a vertical axis of the wind turbine. The operations of 1010 may be performed in accordance with examples as disclosed herein. In some examples, aspects of the operations of 1010 may be performed by a speed control assembly of a wind turbine as described with reference to FIGS. 1 through 8.

At 1015, the method may include controlling, via a torsion spring of the wind turbine, when a rear stop of the speed control assembly exerts a force on the airfoil to reduce the rotational speed of the wind turbine, where the torsion spring is configured to facilitate the rear stop to exert the force on the airfoil when a rotational speed of the wind turbine around the vertical axis exceeds a set rotational speed, where a portion of the vane shaft is inserted into a helical portion of the torsion spring. The operations of 1015 may be performed in accordance with examples as disclosed herein. In some examples, aspects of the operations of 1015 may be performed by a speed control assembly of a wind turbine as described with reference to FIGS. 1 through 8.

At 1020, the method may include inserting an upper end of the torsion spring into an aperture of the rear stop. The operations of 1020 may be performed in accordance with examples as disclosed herein. In some examples, aspects of the operations of 1020 may be performed by a speed control assembly of a wind turbine as described with reference to FIGS. 1 through 8.

At 1025, the method may include inserting a lower end of the torsion spring into an aperture of a support arm of the wind turbine assembly. The operations of 1025 may be performed in accordance with examples as disclosed herein. In some examples, aspects of the operations of 1025 may be performed by a speed control assembly of a wind turbine as described with reference to FIGS. 1 through 8.

At 1030, the method may include attaching the vane shaft to the support arm. The operations of 1030 may be performed in accordance with examples as disclosed herein. In some examples, aspects of the operations of 1030 may be performed by a speed control assembly of a wind turbine as described with reference to FIGS. 1 through 8.

It should be noted that the methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A speed control assembly of a wind turbine for dynamic rotational speed control of the wind turbine, the speed control assembly comprising:
an airfoil configured to rotate around a vertical axis of the wind turbine;
a vane shaft attached to a support arm of the wind turbine, the vane shaft partially inserted into a cylindrical aperture of the airfoil; and
a torsion spring configured to control when a rear stop of the speed control assembly exerts a force on the airfoil to reduce the rotational speed of the wind turbine, wherein the torsion spring is configured to facilitate the rear stop to exert the force on the airfoil when a rotational speed of the wind turbine around the vertical axis exceeds a set rotational speed, wherein a portion of the vane shaft is inserted into a helical portion of the torsion spring.

2. The speed control assembly of claim 1, wherein the torsion spring is at rest when the rear stop is at rest.

3. The speed control assembly of claim 1, wherein at least the helical portion of the torsion spring is positioned within a cylindrical sleeve of the wind turbine assembly, wherein the rear stop is connected to or is an extension of the cylindrical sleeve.

4. The speed control assembly of claim 1, further comprising:
an upper end of the torsion spring that is inserted into an aperture of the rear stop; and
a lower end of the torsion spring that is inserted into an aperture of a support arm of the wind turbine assembly, wherein the vane shaft attaches to the support arm.

5. The speed control assembly of claim 1, further comprising:
a rotation weight that attaches to the rear stop, wherein when the rotational speed of the wind turbine assembly does not exceed the set rotational speed, then the rotation weight is at rest and the rear stop is at rest against a rear brace attached to the support arm.

6. The speed control assembly of claim 5, further comprising:
a rear plate extending from a surface of the airfoil, wherein the torsion spring is configured to allow the rotation weight and the rear stop to rotate on an axis of the vane shaft towards a planar surface of the rear plate when the rotational speed of the wind turbine assembly exceeds the set rotational speed.

7. The speed control assembly of claim 6, wherein a tension of the torsion spring increases when the rotation weight and the rear stop rotate towards the rear plate, wherein the rotation weight attaches to a planar surface of the rear stop.

8. The speed control assembly of claim 1, further comprising:
wherein the aperture of the airfoil is positioned at a quarter chord point of the airfoil.

9. The speed control assembly of claim 1, wherein the support arm extends from the vane shaft to a center shaft of the wind turbine, and wherein the vertical axis of the wind turbine is centered at the center shaft.

10. A method for dynamic rotational speed control by a speed control assembly of a wind turbine, comprising:
attaching a vane shaft to a support arm of the wind turbine, the vane shaft partially inserted into a cylindrical aperture of an airfoil of the wind turbine;
rotating an airfoil around a vertical axis of the wind turbine; and
controlling, via a torsion spring of the wind turbine, when a rear stop of the speed control assembly exerts a force on the airfoil to reduce the rotational speed of the wind turbine, wherein the torsion spring is configured to facilitate the rear stop to exert the force on the airfoil when a rotational speed of the wind turbine around the vertical axis exceeds a set rotational speed, wherein a portion of the vane shaft is inserted into a helical portion of the torsion spring.

11. The method of claim 10, wherein the torsion spring is at rest when the rear stop is at rest.

12. The method of claim 10, wherein at least the helical portion of the torsion spring is positioned within a cylindrical sleeve of the wind turbine assembly, wherein the rear stop is connected to or is an extension of the cylindrical sleeve.

13. The method of claim 10, further comprising:
inserting an upper end of the torsion spring into an aperture of the rear stop;
inserting a lower end of the torsion spring into an aperture of a support arm of the wind turbine assembly; and
attaching the vane shaft to the support arm.

14. The method of claim 10, further comprising:
attaching a rotation weight to the rear stop, wherein when the rotational speed of the wind turbine assembly does not exceed the set rotational speed, then the rotation weight is at rest and the rear stop is at rest against a rear brace attached to the support arm.

15. The method of claim 14, further comprising:
configuring the rotation weight and the rear stop to rotate on an axis of the vane shaft towards a planar surface of a rear plate when the rotational speed of the wind turbine assembly exceeds the set rotational speed, wherein the rear plate extends from a surface of the airfoil.

16. The method of claim 15, wherein a tension of the torsion spring increases when the rotation weight and the rear stop rotate towards the rear plate, wherein the rotation weight attaches to a planar surface of the rear stop.

17. The method of claim 10, wherein the aperture of the airfoil is positioned at a quarter chord point of the airfoil.

18. The method of claim 10, wherein the support arm extends from the vane shaft to a center shaft of the wind turbine, and wherein the vertical axis of the wind turbine is centered at the center shaft.
